(19) United States
(12) Patent Application Publication
(10) Pub. No.: US 2005/0141534 A1
(43) Pub. Date: Jun. 30, 2005

(54) Packet processing method and device

(75) Inventors: Manabu Kawabata, Osaka (JP); Junichi Yasui, Osaka (JP)

Correspondence Address: PARKHURST & WENDEL, L.L.P., 1421 PRINCE STREET, SUITE 210, ALEXANDRIA, VA, 22314-2805, US

(73) Assignee: Matsushita Elec. Ind. Co. Ltd., Kadoma-shi (JP)

(21) Appl. No.: 10/986,465

(22) Filed: Nov. 12, 2004

(30) Foreign Application Priority Data
Nov. 12, 2003 (JP) 2003-381878
Apr. 23, 2004 (JP) 2004-127471

(51) Int. Cl. H04L 12/28; H04L 12/56

(52) U.S. Cl. 370/411; 370/474

(57) ABSTRACT

Packet processing method and device. The device includes: a storage device for storing data; a transfer device for dividing the data into a plurality of data with a predetermined length and arranging the divided data at intervals in the storage device while securing a first blank area for attaching a protocol header to the divided data and a second blank area for attaching a protocol footer to the divided area; a read address control device for implementing access of data arranged at intervals in the storage device as continuous data; and a write address control device for storing the protocol header to be attached in the first blank area and the protocol footer to be attached in the second blank area when the packet conversion processing is performed on the divided data.

### BACKGROUND OF THE INVENTION

1. Field of the Invention

The present invention relates to a packet processing method and device, and more particularly to a packet processing method and device for converting data into packets conforming to the communication protocol for communication between networks.

2. Description of the Related Art

The packet conversion processing of data is generally performed as follows. In other words, data transmitted to a network is divided if it exceeds the data length defined according to the restrictions of the maximum transmission units and the purpose of the network which performs communication. Each divided data is processed by the protocol stack. By this processing, a plurality of protocol headers and protocol footers are attached to each data, and packets that can be transmitted on the network are created. In these processing steps, each data is simply copied from an area of a memory allocated by the user or from an application program to another area of dedicated memory used by the processor each time a protocol header or protocol footer is attached. Since each data to be transmitted by packets is independently copied, the load to be applied on the processor is high and a large amount of bandwidth of the memory bus is used because of frequent transmission (JP-A-2002-538731).

### SUMMARY OF THE INVENTION

In the above mentioned known processing method, a copy of each data is required each time a protocol header and protocol footer is attached in the protocol stack processing. So the time required for the processor to execute the processing increases and throughput drops.

To solve this problem, it is an object of the present invention to provide a packet conversion processing method and packet conversion processing device for decreasing the number of copies to memory in the packet conversion processing steps, and improving throughput.

The present invention for the packet processing method solves the above problem by using the following processing steps.

A packet processing method for converting data into packets conforming to a communication protocol for communicating data between networks comprises steps of: dividing the data into a plurality of divided data with a predetermined data length; storing the divided data; securing a first blank area corresponding to the divided data in an area before a storage area for storing each of the divided data when the divided data is stored; securing a second blank area corresponding to the divided data in an area after the storage area for storing each of the divided data; storing a protocol header to be attached in the first blank area when the packet conversion processing is executed on the divided data; storing a protocol footer to be attached in the second blank area when the packet conversion processing is executed on the divided data; and identifying the data in the storage area, including the protocol header and protocol footer attached to each divided data, as one packet.

By using these processing steps, when a protocol header and/or protocol footer are/is attached by the packet conversion processing for the data, the data, including the protocol header and/or protocol footer, need not be copied from a dedicated memory of the processor used for packet conversion processing to a user space (e.g. data storage device of an application program). Instead only the protocol header and/or protocol footer to be attached can be copied to the first blank area and second blank area secured in the user space.

The packet processing device for implementing the packet processing method according to the present invention solves the above problem by the following configuration.

A first packet processing device according to the present invention comprises: a storage device for storing data; a transfer device for dividing the data into a plurality of data with a predetermined length and arranging the divided data at intervals in the storage device while securing a first blank area for attaching a protocol header to the divided data and a second blank area for attaching a protocol footer to the divided data; a read address control device for implementing access of the data arranged at intervals in the storage device as continuous data; and a write address control device for storing the protocol header to be attached in the first blank area and protocol footer to be attached in the second blank area when the packet conversion processing is executed on the divided data.

By this, when a protocol header and/or protocol footer are/is attached by the packet conversion processing for the data, the data, including the protocol header and/or protocol footer, need not be copied from a dedicated memory of the processor used for packet conversion processing to the storage device, and only the protocol header and/or protocol footer to be attached can be copied to the first blank area and/or second blank area secured in the storage device, and the throughput of the packet conversion processing for data can be improved.

According to the first packet processing device, it is preferable to further comprise a register for arbitrarily setting the data length of the divided data, the size of the first blank area and the size of the second blank area respectively, so that the arrangement of divided data at intervals in the storage device can be controlled with more flexibility.

It is preferable that the transfer device is a DMAC having a function of continuously transferring data while adding an arbitrary value to the transfer destination address for each transfer count that is set, when the data is transferred from the transfer source side to the transfer destination side, and implementing the arrangement of the divided data at intervals in the storage device by continuously transferring the next data with adding the sum of the address count in the first blank area and the address count in the second blank area to the transfer destination address, each time data is transferred to the storage device for the amount corresponding to the data length of the divided data.

It is preferable that the read address control device and the write address control device are updated each time the protocol header and/or protocol footer are/is attached, and the packet processing device further comprises a first register to indicate the size of the divided data storage area in the storage device at an arbitrary point of time, a second register to be updated each time a protocol header is attached and to indicate the size of the blank area for storing the protocol header in the storage device at an arbitrary point of time, and a third register to be updated each time a protocol footer is attached and to indicate the size of the blank area for storing the protocol footer in the storage device at an arbitrary point of time. These are effective to implement a plurality of protocol stack processings for the data.

It is preferable that the read address control device comprises a function for calculating the size of the blank area between the divided data stored in the storage device from the sum of the value of the second register and the value of the third register, and can implement continuous access to the divided data arranged at intervals by adding the calculated value to the address of the access destination for each read count corresponding to the value of the first register when the divided data is accessed from outside of the storage device.

It is preferable that the write address control device further comprises a function to calculate an interval address value of the protocol header storage area corresponding to each divided data by multiplying the sum of the value of the first register, the value of the second register and the value of the third register by the count of attaching the protocol header, and then adding an offset value that is a result after the size of the protocol header to be attached is subtracted from the value of the second register, and to calculate the interval address value of the protocol footer storage area corresponding to each divided data by multiplying a value that is a result after the size of the protocol footer to be attached is subtracted from the sum of the value of the first register, the value of the second register and the value of the third register by the count of attaching the protocol footer. According to this, the calculated value is added to the storage destination address each time one protocol header and/or one protocol footer are/is stored in the storage device, therefore the protocol header and/or protocol footer can be attached to each of the divided data arranged at intervals in the storage device.

For the size of the protocol header and/or protocol footer, a standard Ethernet® supported TCP/IP, for example, may be preset for each protocol, such as a TCP header is 20 or 24 bytes, an IP header is 20 bytes or more and 60 bytes or less, an Ethernet® header is 14 bytes, and a CRC to be a footer is 4 bytes. Or a dedicated counter for counting each data length of the protocol header and/or protocol footer to actually be attached to the data, in the step of performing the packet conversion processing on data, may be disposed so as to calculate the size each time.

In the second packet processing device according to the present invention, the transfer device work area on the storage device, required for the packet conversion processing, can be dramatically decreased by constructing a transfer device as follows.

The second packet processing device according to the present invention comprises a storage device for storing data, a CPU for executing packet processing on data stored in the storage device as one of the tasks, and a transfer device for transferring data between the storage device and the CPU, wherein the transfer device infinitely loops the transfer destination address on the storage device within a predetermined area by initializing the transfer destination address of the data for each transfer count that can be arbitrarily set.

By this, continuous packet processing can be implemented in a less sized memory space, and when image data is transmitted over a network in real-time, that is when packet conversion processing is continuously executed on the data and is continuously transmitted over the network, for example, the work area on the storage device, required for packet conversion processing, can be dramatically decreased.

It is preferable that the second packet processing device according to the present invention further comprises a wait instruction control device for calculating the difference between the final address of the storage area storing the data for which packet processing is completed in the storage device and a transmission destination address when data is transmitted from the transfer device to the storage device, and outputting a wait control signal to the transfer device when the calculated address difference value is smaller than an address difference value that was preset. By this, an overwrite of the packet processing uncompleted data by the transfer device can be prevented.

It is also possible that the wait instruction control device further comprises a register for setting the address difference value arbitrarily, so that an overwrite of the packet processing uncompleted data by the transfer device can be prevented more flexibly.

It is suitable that the transfer device temporarily stops data transfer from the transfer device to the storage device when a wait control signal is input from the wait instruction control device. By this, an overwrite of the packet processing uncompleted data by the transfer device can be prevented.

It is also preferable that the transfer device further comprises a counter for counting the input count of a wait control signal to be input from the wait instruction control device, and a control unit for temporarily stopping data transfer from the transfer device to the storage device when the count value of this counter reaches a preset value, and by this, an overwrite of the packet processing uncompleted data by the transfer device can be prevented more flexibly.

It is also preferable that when a wait control signal is input from the wait instruction control device, the transfer device outputs an interrupt request with a high priority level to the CPU, so as to increase the priority of the packet processing for the other tasks of the CPU.

It is also preferable that when the count value by the counter reaches a preset count, the transfer device outputs an interrupt request with a high priority level to the CPU, so as to increase the priority of the packet processing for the other tasks of the CPU. By this, the case when the wait control signal from the wait instruction control device is generated frequently, that is the case when the throughput of the packet processing drops, can be effectively handled.

It is also preferable that when an interrupt request is output to the CPU, the transfer device outputs an interrupt request with a priority level corresponding to the calculated address difference value, and outputs an interrupt request with a higher priority level to increase the priority of the packet processing as the calculated address difference value becomes smaller. By this, a more flexible packet processing, including the priority of the other tasks of the CPU, can be implemented.

According to the present invention, when a protocol header and/or protocol footer are/is attached by the packet conversion processing for the data, the data including the protocol header and/or protocol footer need not be copied from a dedicated memory of the processor used for packet conversion processing to the user space (e.g. data storage device of an application program) each time, and only the protocol header and/or protocol footer to be attached can be copied to the first blank area and/or second blank area secured in the user space, and as a result, the throughput of the packet conversion processing for the data can be improved.

### BRIEF DESCRIPTION OF THE DRAWINGS

FIG. 1 is a diagram depicting a processing mode of an embodiment of the packet processing method of the present invention;

FIG. 2 is a diagram depicting a processing mode of an Ethernet® supported TCP/IP packet processing method of an embodiment of the present invention;

FIG. 3 is a block diagram depicting a configuration of the packet processing device of the present invention;

FIG. 4 is a block diagram depicting a configuration of the DMA in FIG. 3;

FIG. 5 is a block diagram depicting a configuration of the address converter in FIG. 4;

FIG. 6 is a block diagram depicting a configuration of another embodiment of the packet processing device of the present invention;

FIG. 7 is a block diagram depicting a configuration of the DMA in FIG. 6;

FIG. 8 is a block diagram depicting another configuration of the DMA in FIG. 6;

FIG. 9 is a block diagram depicting a configuration of still another embodiment of the packet processing device of the present invention;

FIG. 10 is a block diagram depicting a configuration of still another embodiment of the packet processing device of the present invention;

FIG. 11 is a block diagram depicting a configuration of the DMA in FIG. 10;

FIG. 12 is a block diagram depicting another configuration of the DMA in FIG. 10;

FIG. 13 is a block diagram depicting a configuration of still another embodiment of the packet processing device of the present invention;

FIG. 14 is a block diagram depicting a configuration of the DMA in FIG. 13; and

FIG. 15 is a block diagram depicting another configuration of the DMA in FIG. 13.

### DESCRIPTION OF THE PREFERRED EMBODIMENTS

### First Embodiment

The first embodiment (packet processing method) of the present invention will now be described with reference to the drawings.

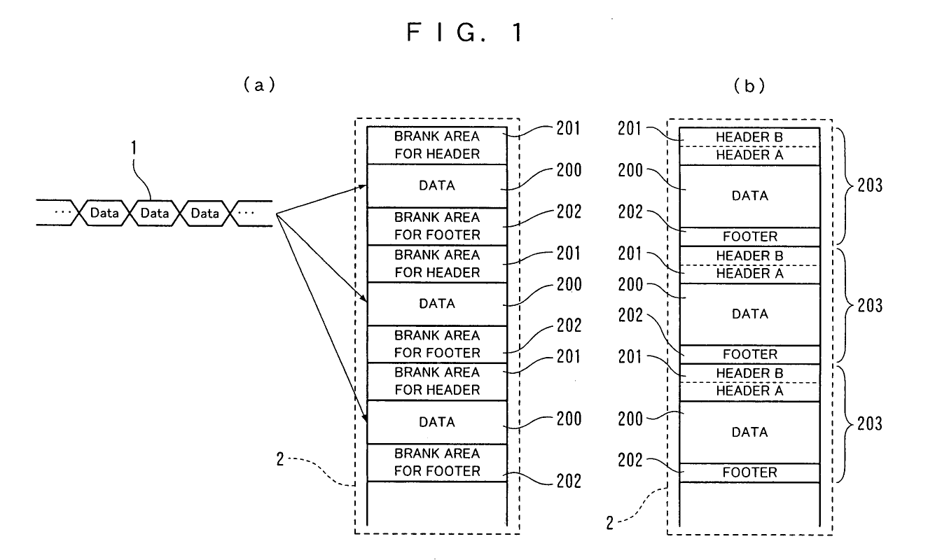

In FIG. 1, 1 denotes a data before executing packet processing, 2 denotes a storage device, 200 denotes a divided data storage area for storing divided data that is the data 1 divided into a predetermined size, 201 denotes a blank area for a header for storing a protocol header corresponding to each divided data in the divided data storage area 200, 202 denotes a blank area for a footer for storing a protocol footer corresponding to each divided data of the divided data storage area 200, and 203 denotes a packet in a status when the protocol header and protocol footer are attached to each divided data by the packet processing.

When data 1 is converted into packets conforming to a communication protocol for communicating data 1 between networks, the data 1 is first divided into a predetermined size, as shown in (a) in FIG. 1, and is stored in the divided data storage area 200 arranged at intervals in the storage device 2 to be a work area for packet conversion processing. At this time, the size of each divided data and the size of the divided data storage area 200 corresponding to each divided data are assumed to be the same. The blank area for a header 201 is secured in the storage area before each divided data storage area 200 in the storage device 2, and the blank area for a footer 202 is secured in the storage area after each divided data storage area 200.

Then packet conversion processing is performed for each divided data stored in the divided data storage area 200. When the packet conversion processing is performed, the protocol header or protocol footer corresponding to each divided data is attached to the divided data, which is converted into a packet. As FIG. 1 (b) shows, the protocol header to be attached is stored in the blank area for a header 201, and the protocol footer to be attached is stored in the blank area for a footer 202. The protocol header is stored such that no blank area is created between the protocol header to be stored in the blank area for a header 201 and the divided data corresponding to this protocol header. The protocol footer is stored such that no blank area is created between the protocol footer to be stored in the blank area for a footer 202 and the divided data corresponding to this protocol footer.

In FIG. 1 (b), if a plurality of protocol headers are attached to a divided data in the packet conversion processing, such as “header A” and “header B” shown in FIG. 1 (b), the protocol header to be attached later (header B) is stacked sequentially in the blank area in front of the protocol header (header A) which is stored in the blank area for a header 201 initially in the steps of the packet conversion processing. At this time, each protocol header is stored such that no blank area exists between them. If a plurality of protocol footers are attached to a divided data in the packet conversion processing, on the other hand, the protocol footer to be attached later is sequentially stacked in the blank area behind the protocol footer stored in the blank area for a footer 202 initially in the steps of the packet conversion processing. At this time, each protocol footer is stored such that no blank area exists between them. When all the protocol headers and protocol footers corresponding to each divided data are attached by the pocket conversion processing for the divided data, the packets 203 are created in the storage device 2, as shown in FIG. 1 (b).

An outline of an embodiment of the packet processing method of the present invention was described above, and now details of the embodiment of the packet processing method of the present invention will be described with reference to the drawings using TCP/IP packet processing as an example.

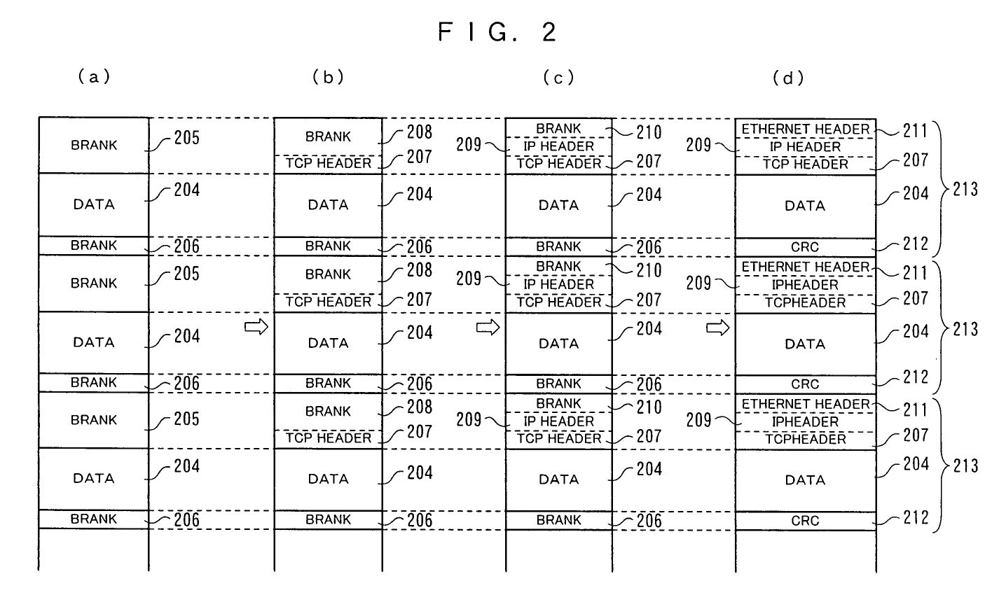

FIG. 2 is a diagram depicting a mode of the Ethernet® supported TCP/IP packet processing method of an embodiment of the present invention. Here 204 denotes a data storage area where divided data is already stored, 205 denotes a blank area for a header, 206 denotes a blank area for a footer, 207 denotes a TCP header, 208 denotes a blank area for a header, 209 denotes an IP header, 210 denotes a blank area for a header, 211 denotes an Ethernet® header, 212 denotes a CRC and 213 denotes a packet.

(a) in FIG. 2 shows a initial status when the divided data is stored in the storage device to be a work area for the Ethernet® supported TCP/IP packet. A blank area for a header 205 and a blank area for a footer 206, corresponding to the divided data storage area 204, are secured before and after each divided data storage area 204.

(b) in FIG. 2 shows a status when the TCP header 207 is attached to each divided data in steps of the Ethernet® supported TCP/IP packet conversion processing. The TCP header 207, corresponding to each divided data of the divided data storage area 204 is stored in the blank area for a header 205 in FIG. 2 (a) corresponding to each divided data storage area 204. At this time, in each blank area for a header 205, the blank area for a header 208, after the storage area for the TCP header 207 is removed, remains.

(c) in FIG. 2 shows a status when the IP header 209 is attached to each divided data in the steps of the Ethernet® supported TCP/IP packet conversion processing. The IP header 209, corresponding to each divided data of the divided data storage area 204 and each TCP header 207, is stored in the blank area for a header 208 of FIG. 2 (b) corresponding to each divided data storage area 204. At this time, in each blank area for a header 208, the blank area for a header 210, after the storage area for the IP header 209 is removed, remains.

(d) in FIG. 2 shows a status when the Ethernet® header 211 and the CRC 212 are attached to each divided data in the steps of the Ethernet® supported TCP/IP packet conversion processing. The Ethernet® header 211 corresponding to each divided data of the divided data storage area 204, each TCP header 207 and each IP header 209 are stored in the blank area for a header 210 of FIG. 2 (c) corresponding to each divided data storage area 204. The CRC 212 corresponding to each divided data of the divided data storage area 204, each TCP header 207, each IP header 209 and each Ethernet® header 211 are stored in the blank area for a footer 206 of FIG. 2 (a)-(c) corresponding to each divided data storage area 204. By this, the packets 213 are created in the storage device.

The embodiment of the packet processing method of the present invention was described above using TCP/IP packet processing as an example. Now an embodiment of the packet processing device for implementing the packet conversion processing method of the present invention will be described with reference to the drawings.

### Second Embodiment

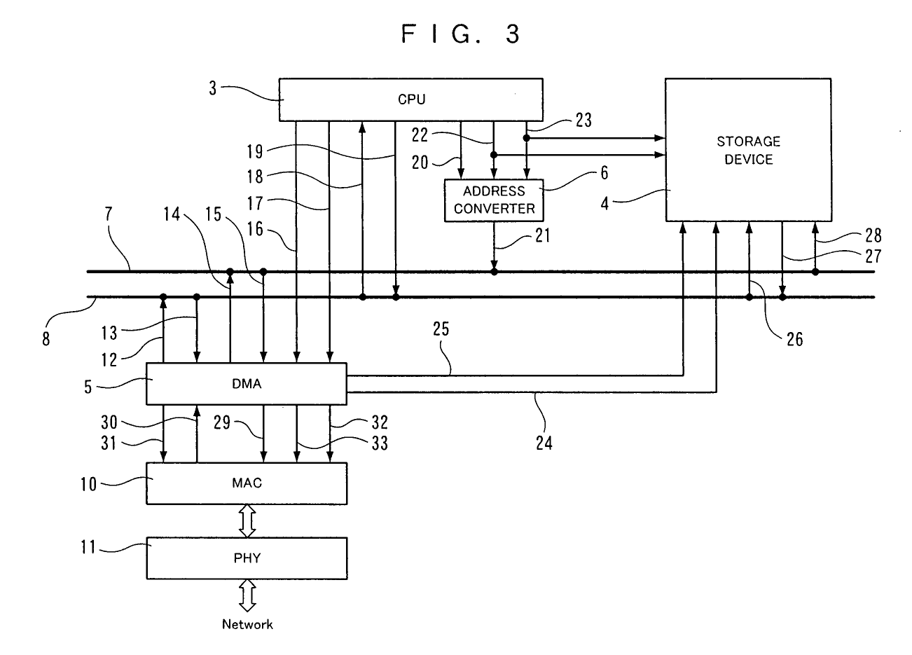

FIG. 3 is a block diagram depicting a configuration of the packet processing device according to the second embodiment of the present invention. Here 3 denotes a CPU, 4 denotes a storage device, 5 denotes a DMA, 6 denotes an address converter for converting address data when the CPU 3 accesses the storage device 4, 7 denotes a bi-directional address bus for transferring the address data among the CPU 3, storage device 4 and DMA 5, 8 denotes a bi-directional data bus for transferring data among the CPU 3, storage device 4, and DMA 5, 10 denotes a media access controller (hereafter “MAC”) comprising a data buffer for controlling connection with a network, 11 denotes a PHY which is a physical interface with a network, 12 denotes a data bus for transferring data from the DMA 5 to the data bus 8, 13 denotes a data bus for transferring data from the data bus 8 to the DMA 5, 14 denotes an address bus for transferring address data from the DMA 5 to the address bus 7, 15 denotes an address bus for transferring address data from the address bus 7 to the DMA 5, 16 denotes a received data transfer request signal to be output from the CPU 3 to the DMA 5 for instructing the transfer of data received by the MAC 10 via the PHY 11 to the storage device 4, 17 denotes a transmission data transfer request signal to be output from the CPU 3 to the DMA 5 for instructing the transfer of data of the storage device 4 to the MAC 10, 18 denotes a data bus for transferring data from the data bus 8 to the CPU 3, 19 denotes a data bus for transferring data from the CPU 3 to the data bus 8, 20 denotes an address bus for transferring address data from the CPU 3 to the address converter 6, 21 denotes an address bus for transferring the address data, which is converted by the address converter 6, from the address converter 6 to the address bus 7, 22 denotes a read request signal to be output from the CPU 3 to the storage device 4 and the address converter 6 to instruct the storage device 4 to read data, 23 denotes a write request signal to be output from the CPU 3 to the storage device 4 and the address converter 6 to instruct the storage device 4 to write data, 24 denotes a write request signal to be output from the DMA 5 to the storage device 4 to instruct the storage device 4 to write data, 25 denotes a read request signal to be output from the DMA 5 to the storage device 4 to instruct the storage device 4 to read data, 26 denotes a data bus for transferring data from the data bus 8 to the storage device 4, 27 denotes a data bus for transferring data from the storage device 4 to the data bus 8, 28 denotes an address bus for transferring the address data from the address bus 7 to the storage device 4, 29 denotes an address bus for transferring the address data from the DMA 5 to the MAC 10, 30 denotes a data bus for receiving to transfer the received data from the network, from the MAC 10 to the DMA 5, 31 denotes a data bus for transmission to transfer the transmitted data to the network, from the DMA 5 to the MAC 10, 32 denotes a read request signal to be output from the DMA 5 to the MAC 10 for reading the received data from the data buffer of the MAC 10, and 33 denotes a write request signal to be output from the DMA 5 to the MAC 10 for storing the transmitted data to the data buffer of the MAC 10.

The data bus 12 and the data bus 13, the address bus 14 and the address bus 15, the data bus 18 and the data bus 19, the data bus 26 and the data bus 27, the data bus for receiving 30 and the data bus for transmission 31 may be constructed by a bi-directional bus respectively.

The data received by the PHY 11 is temporarily stored in a data buffer in the MAC 10. To transfer this received data temporarily stored in the data buffer to the storage device 4, the CPU 3 outputs the received data transfer request signal 16 and the first address data to be the data transfer destination of the storage device 4 to the DMA 5. At this time, the address data to be output by the CPU 3 is input to the address converter 6 via the address bus 20, but nothing is processed by the address converter 6, and this address data is output to the address bus 21 and is input to the DMA 5 via the address bus 7 and the address bus 15. The conversion of the address data by the address converter 6 will be described later. When the received data transfer request signal 16 and the address data are input, the DMA 5 starts transferring the received data, which is temporarily stored in the data buffer of the MAC 10, to the storage area of the storage device 4 indicated by the address data that was input from the data buffer of the MAC 10. At this time, the DMA 5 divides the data into predetermined sizes, as shown in FIG. 2 (a), and arranges the divided data at intervals in the storage device 4.

Now data division and the arrangement of the divided data at intervals by the DMA 5 will be described with reference to the drawings.

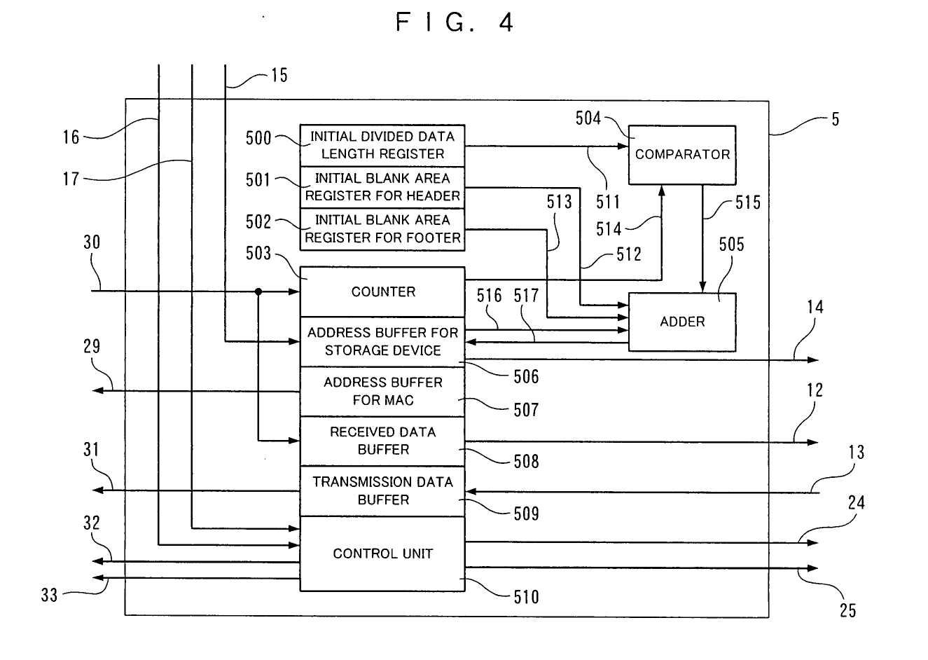

FIG. 4 is a block diagram depicting the configuration of the DMA 5. 500 denotes an initial divided data length register, 501 denotes an initial blank area register for a header, 502 denotes an initial blank area register for a footer, 503 denotes a counter for counting the transfer count of the data to be input from the data bus for receiving 30, 504 denotes a comparator for comparing the value of the initial divided data length register 500 and the value of the counter 503, 505 denotes an adder for adding to address data according to the comparison result of the comparator 504, 506 denotes an address buffer for storage device for storing the address data for specifying the address in the storage device 4 in FIG. 3, 507 denotes an address buffer for a MAC for storing the address data for specifying the address in the data buffer of the MAC 10 in FIG. 3, 508 denotes a received data buffer for storing data to be input from the data bus for receiving 30, 509 denotes a transmission data buffer for storing data to be input from the data bus 13 and 510 denotes a control unit. 511 denotes an initial divided data length information X which is the size of each divided data to be arranged in the storage device 4 in FIG. 3, indicated by an address count in the storage device 4, 512 denotes a size information Y of an initial blank area for a header which is the size of each blank area for a protocol header to be arranged in the storage device 4, indicated by an address count in the storage device 4, 513 denotes a size information Z of an initial blank area for a footer which is the size of each blank area for a protocol header to be arranged in the storage device 4, indicated by the address count in the storage device 4, 514 denotes a transfer count information which is a count value of the counter 503, 515 denotes a comparison result to be output from the comparator 504 to the adder 505, 516 denotes address data to be input from the address buffer for storage device 506 to the adder 505, and 517 denotes an address data to be output from the adder 505 to the address buffer for storage device 506.

In the initial divided data length register 500, the initial divided data length information X, to indicate the size of each divided data for arranging the divided data in the storage device 4 shown in FIG. 3, is stored in advance. In the same way, in the initial blank area register for a header 501, the size information Y of the initial blank area for a header, to indicate the size of each blank area for a protocol header to be arranged in the storage device 4, is stored in advance, and in the initial blank area register for a footer 502, the size information Z of the initial blank area for a footer, to indicate the size of each blank area for a protocol footer to be arranged in the storage device 4, is stored in advance.

When the received data transfer request signal 16 and the address data are input from the CPU 3 to the DMA 5 in FIG. 3, the received data transfer request signal 16 is input to the control unit 510, and the address data is stored in the address buffer for storage device 506 via the address bus 15. When the received data transfer request signal 16 is input to the control unit 510, the control unit 510 outputs the read request signal 32 to the MAC 10, and outputs the address data to be the read destination of the data buffer of the MAC 10 to the address bus 29. At this time, the address data to be output to the address bus 29 is the address data stored in the address buffer for MAC 507, and the address data stored in the address buffer for MAC 507 is sequentially updated by the control unit 510. The received data stored in the data buffer of the MAC 10 is transferred to the DMA 5 via the data bus for receiving 30, and is stored in the received data buffer 508 by the read request signal 32 and the address data of the address bus 29. At this time, the control unit 510 continuously outputs the read request signal 32 to the MAC 10, and continuously outputs the address data stored in the address buffer for MAC 507 to the address bus 29, so as to continuously transfer data from the data buffer of MAC 10 to the DMA 5.

The counter 503 counts the transfer count of the data to be input from the data bus for receiving 30. The transfer count information 514 counted by the counter 503 is input to the comparator 504. If the transfer count information 514, which was input from the counter 503, is “a value indicating that the transfer count is 1”, the comparator 504 outputs the data “00” to the adder 505 as the comparison result 515. If the transfer count information 514, which was input from the counter 503, is “a value indicating that the transfer count is 2 or more”, the comparator 504 compares the values of the initial divided data length information X 511, which is read from the initial divided data length register 500, and the transfer count information 514, which is input from the counter 503, and if the transferred data volume indicated by the transfer count information 514 is smaller than the data volume indicated by the initial divided data length information X 511, the comparator 504 outputs the data “01” to the adder 505 as the comparison result 515. On the other hand, if the transferred data volume indicated by the transfer count information 514 is the same as the data volume indicated by the initial divided data length information X 511, when the transfer count information 514 which is input from the counter 503 is “a value indicating that the transfer count is 2 or more”, the comparator 504 outputs the data “10” to the adder 505 as the comparison result 515.

The adder 505 reads the address data 516 from the address buffer for storage device 506 in advance, and if the comparison result 515, which is input from the comparator 504, is the data “00”, the adder 505 adds the size information Y 512 of the initial blank area for a head, which is read from the initial blank area register for a header 501, to the address data 516, and stores the addition result in the address buffer for storage device 506 as the address data 517. If the comparison result 515, which is input from the comparator 504, is the data “01”, the adder 505 increments the address data 516, and stores the result to the address buffer for storage device 506 as the address data 517. If the comparison result 515, which is input from the comparator 504, is the data “10”, the adder 505 adds the size information Y 512 of the initial blank area for a header, which is read from the initial blank area register for a header 501 and the size information Z 513 of the initial blank area for a footer which is read from the initial blank area register for a footer 502, to the address data 516, and stores the addition result in the address buffer for storage device 506 as the address data 517.

When the address buffer for storage device 506 becomes full, the control unit 510 sequentially outputs the address data stored in this address buffer for storage device 506 to the address bus 14 and the data stored in the data buffer for receiving 508 to the data bus 12, and outputs the write request signal 24 to the storage device 4. The address data to be output to the address bus 14 is input to the storage device 4 via the address bus 7 and address bus 28, and the data to be output to the data bus 12 is input to the storage device 4 via the data bus 8 and data bus 26. In this case, data transfer from the DMA 5 to the storage device 4 is started when the address buffer for storage device 506 becomes full, but data transfer from the DMA 5 to the storage device 4 may be sequentially executed each time one address data is stored in the address buffer for storage device 506.

In this way, the DMA 5 divides the data stored in the data buffer of the MAC 10 into the size based on the initial divided data length information X which is set in the initial divided data length register 500, and arranges each divided data at intervals in the storage device 4 while securing the blank area with a size based on the size information Y of the initial blank area for a header, which is set in the initial blank area register for a header 501, and the size information Z of the initial blank area for a footer, which is set in the initial blank area register for a footer 502.

The division of the data and the arrangement of the divided data at intervals by the DMA 5 were described above, and now the packet conversion processing for each divided data arranged at intervals in the storage device 4 will be described.

In order to execute packet conversion processing for each divided data arranged at intervals in the storage device 4, the CPU 3 reads the divided data in the storage device 4. At this time, it is preferable that the CPU 3 reads only the divided data arranged at intervals in the storage device 4, and does not access the blank area for a header and the blank area for a footer which are secured before and after each divided data. In order to execute packet conversion processing for each divided data which is arranged at intervals in the storage device 4, the CPU 3 attaches the corresponding protocol header and the protocol footer to the divided data read from the storage device 4. At this time, the CPU 3 must write only the protocol header in the blank area for a header, which is secured before each divided data arranged at intervals in the storage device 4, and write only the protocol footer in the blank area for a footer, which is secured after each divided data.

Now the address converter 6, which is means for performing such address control, will be described with reference to the drawings.

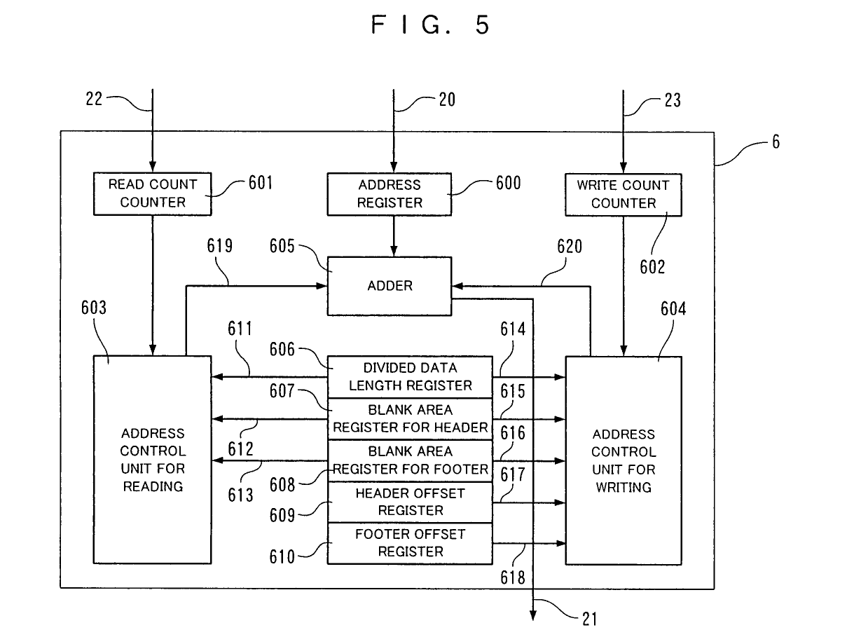

FIG. 5 is a block diagram depicting the configuration of the address converter 6. Here 600 denotes an address register, 601 denotes a read count counter for counting the read request signal 22 which the CPU 3 outputs to the storage device 4, 602 denotes a write count counter for counting the write request signal 23 which the CPU 3 outputs to the storage device 4, 603 denotes an address control unit for reading, 604 denotes an address control unit for writing, 605 denotes an address adder for adding to the value of the address register 600 according to the input from the address control unit for reading 603 and the address control unit for writing 604, 606 denotes a divided data length register which is sequentially updated each time a protocol header or protocol footer is attached to the divided data, 607 denotes a blank area register for a header, which is sequentially updated each time a protocol header is attached to the divided data, 608 denotes a blank area register for a footer, which is sequentially updated each time a protocol footer is attached to the divided data, 609 denotes a header offset register for storing the address offset information of the attached header, and 610 denotes a footer offset register for storing the address offset information of the attached footer. 611 denotes a divided data length information X′ for indicating the size of each divided data at an arbitrary point of time by the address count in the storage device 41, 612 denotes a size information Y′ of the blank area for a header for indicating the size of each blank area for a header at an arbitrary point of time by the address count in the storage device 4, 613 denotes a size information Z′ of the blank area for a footer for indicating the size of each blank area for a footer at an arbitrary point of time by the address count in the storage device 4, 614 denotes the divided data length information X′ for indicating the size of each divided data at an arbitrary point of time by the address count in the storage device 4 (same information as 611), 615 denotes the size information Y′ of the blank area for a header indicating the size of each blank area for a header at an arbitrary point of time by the address count in the storage device 4 (same information as 612), 616 denotes the size information Z′ of the blank area for a footer for indicating the size of each blank area for a footer at an arbitrary point of time by the address count in the storage device 4 (same information as 613), 617 denotes an address offset information Hoff of the attached header, 618 denotes an address offset information Foff of the attached footer, 619 denotes an addition value information for reading, and 620 denotes an addition value information for writing.

In the divided data length register 606, the divided data length information X′, which indicates the size of each divided data at an arbitrary point of time by the address count in the storage device 4, is stored, and the initial value of the divided data length information X′ is the initial divided data length information X. In the blank area register for a header 607, the size information Y′ of the blank area for a header, which indicates the size of each blank area for a header at an arbitrary point of time by the address count in the storage device 4, is stored, and the initial value of the size information Y′ of the blank area for a header is the size information Y of the initial blank area for a header. In the blank area register for a footer 608, the size information Z′ of the blank area for a footer, which indicates the size of each blank area for a footer at an arbitrary point of time by the address count in the storage device 4, is stored, and the initial value of the size information Z′ of the blank area for a footer is the size information Z of the initial blank area for a footer.

In the header offset register 609, the address offset information Hoff of the attached header, which indicates the size of the protocol header to be attached by the address count in the storage device 4, is stored each time according to the protocol header to be attached, and in the footer offset register 610, the address offset information Foff of the attached footer, which indicates the size of the protocol footer to be attached by the address count in the storage device 4, is stored each time according to the protocol footer to be attached. The address offset information Hoff of the attached header and the address offset information Foff of the attached footer may be set for each protocol in advance according to the protocol to be processed, or an address count counter for counting the address count, which indicates the size of the protocol header and the protocol footer to be actually attached, may be installed separately, so that the count value of the address count counter is used as the address offset information Hoff of the attached header or the address offset information Foff of the attached footer.

Now the operation of the address converter 6 with the above configuration will be described. First the CPU 3 reads the divided data in the storage device 4 to execute the packet conversion processing for each divided data which is arranged at intervals in the storage device 4 in FIG. 3. At this time, as the address data to indicate the beginning of the read destination in the storage device 4, the CPU 3 outputs the address data, which is the same as the address data specified in the DMA 5, as the first address data to be the data transfer destination when the DMA 5 transfers data to the storage device 4. The address data to indicate the read destination in the storage device 4, which the CPU 3 outputs, is input to the address converter 6 via the address bus 20, and is stored in the address register 600 in FIG. 5. The read request signal 22, which the CPU 3 outputs to the storage device 4, is also input to the address converter 6. The read count counter 601 counts the read request signal 22 to be input to the address converter 6, and outputs the count value to the address control unit for reading 603. The address control unit for reading 603 reads the divided data length information X′ 611, the size information Y′ 612 of the blank area for a header, and the size information Z′ 613 of the blank area for a footer from the divided data length register 606, blank area register for a header 607, and blank area register for a footer 608 respectively in advance.

When the count value, which is input from the read count counter 601, is smaller than the value indicated by the divided data length information X′ 611, the address control unit for reading 603 outputs the size information Y′ 612 of the blank area for a header to the adder 605 as the addition value information for reading 619.

When the count value, which is input from the read count counter 601, is the same value as the value indicated by the division data length information X′ 611, the address control unit for reading 603 outputs the result of adding the size information Y′ 612 of the blank area for a header to the sum of the size information Y′ 612 of the blank area for a header and the size information Z′ 613 of the blank area for a footer to the adder 605 as the addition value information for reading 619, and initializes the read count counter 601 at the same time.

If the reading from the CPU 3 to the storage device 4 is continuously executed, the addition value information for reading 619 is defined as follows.

Addition value information for reading 619=[initialized count of the read count counter 601]×{Y′+Z′}+Y′.

The adder 605 adds the addition value information for reading 619, which is input from the address control unit for reading 603, to the address data stored in the address register 600, and outputs the result to the address bus 21 as the post-conversion address data. The read destination address data, which is output to the address bus 21, is input to the storage device 4 via the address bus 7 and the address bus 28. When the read request signal 22, which is output from the CPU 3, and the address data are received, the storage device 4 outputs the data of the address corresponding to the address data to the data bus 27. The data, which is output to the data bus 27, is transferred to the CPU 3 via the data bus 8 and the data bus 18, and the packet conversion processing is executed by the CPU 3.

The operation of the address converter 6, when the CPU 3 reads the divided data arranged at intervals from the storage device 4, was described above, and now the operation when the CPU 3 writes the protocol header and protocol footer to the blank area for a header and the blank area for a footer of the storage device 4 will be described.

At this time, the CPU 3 outputs the data of the protocol header or protocol footer, to be written to the storage device 4, to the data bus 19. As the address data which indicates the beginning of the write destination of the storage device 4, the CPU 3 outputs the address data, which is the same as the address data, which was specified in the DMA 5, as the first address data to be the data transfer destination when data is transferred to the storage device 4 by the DMA 5. In this way, the address data to indicate the write destination of the storage device 4, which the CPU 3 outputs, is input to the address converter 6 via the address bus 20, and is stored in the address register 600. The write request signal 23, which the CPU 3 outputs to the storage device 4, is also input to the address converter 6. The write count counter 602 counts the write request signal 23 to be input to the address converter 6, and outputs the count value to the address control unit for writing 604. The address control unit for writing 604 reads the divided data length information X′ 614, size information Y′ 615 of the blank area for a header, size information Z′ 616 of the blank area for a footer, address offset information Hoff 617 of the attached header and address offset information Foff 618 of the attached footer respectively from the divided data length register 606, blank area register for a header 607, blank area register for a footer 608, header offset register 609 and footer offset register 610 in advance.

To write a protocol header, the address control unit for writing 604 outputs the value after the address offset information Hoff 617 of the attached header is subtracted from the size information Y′ 615 of the blank area for a header, to the adder 605 as the addition value information for writing 620 if the count value, which is input from the write count counter 602, is smaller than the value indicated by the address offset information Hoff 617 of the attached header. If the count value, which is input from the write count counter 602, is the same value as the value indicated by the address offset information Hoff 617 of the attached header, the address control unit for writing 604 adds the value after the address offset information Hoff 617 of the attached header is subtracted from the size information Y′ 615 of the blank area for a header to the sum of the divided data length information X′ 614, the size information Y′ 615 of the blank area for a header, and the size information Z′ 616 of the blank area for a footer, and outputs the result to the adder 605 as the addition value information for writing 620, and initializes the write count counter 602 at the same time.

The addition value information for writing 620, when the writing of the protocol header from the CPU 3 to the storage device 4 is continuously executed, is defined as follows. Addition value information for writing 620 for header writing=[initialized count of the write count counter 602]×{X′+Y′+Z′}+Y′−Hoff.

To write a protocol footer, the address control unit for writing 604 outputs the sum of the divided data length information X′ 614 and the size information Y′ 615 of the blank area for a header to the adder 605 as the addition value information for writing 620 if the count value, which is input from the write count counter 602, is smaller than the value indicated by the address offset information Foff 618 of the attached footer. If the count value, which is input from the write count counter 602, is the same value as the value indicated by the address offset information Foff 618 of the attached footer, the address control unit for writing 604 adds the sum of the divided data length information X′ 614 and the size information Y′ 615 of the blank area for a header to the value after the value of the address offset information Foff 617 of the attached footer is subtracted from the sum of the divided data length information X′ 614, size information Y′ 615 of the blank area for a header, and size information Z′ 616 of the blank area for a footer, and outputs the result to the adder 605 as the addition value information for writing 620, and initializes the write count counter 602 at the same time.

The addition value information for writing 620, when the writing of the protocol footer from the CPU 3 to the storage device 4 is continuously executed, is defined as follows. Addition value information for writing 620 for footer writing=[initialized count of the write count counter 602]×{X′+Y′+Z′−Foff}+X′+Y′.

The adder 605 adds the addition value information for writing 620, which is input from the address control unit for writing 604, to the address data stored in the address register 600, and outputs the result to the address bus 21 as the post-conversion address data. The write destination address data, which is output to the address bus 21, is input to the storage device 4 via the address bus 7 and address bus 28. When the write request signal 23, write data and address data, which the CPU 3 outputs, are received, the storage device 4 writes the data which is input from the data bus 26 via the data bus 19 and data bus 8 to the address corresponding to the address data.

### Third Embodiment

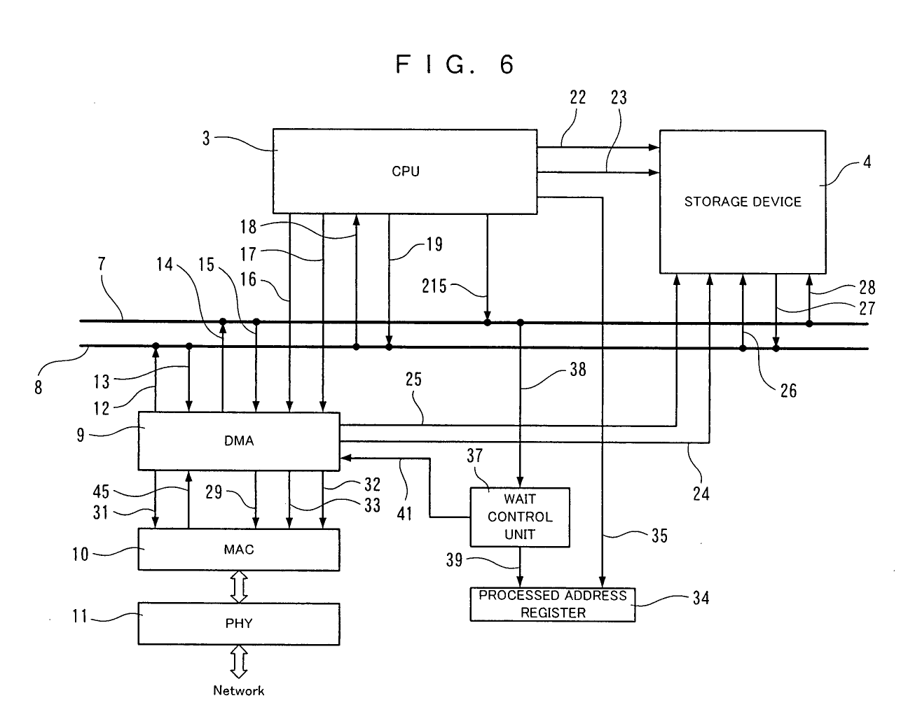

FIG. 6 is a block diagram depicting the configuration of the third embodiment of the packet processing device of the present invention. In the following description, composing elements the same as those in FIG. 3 are denoted with the same reference numerals. Here 9 denotes a DMA, of which details will be described later. In the packet processing device in FIG. 6, the difference from the packet processing device in FIG. 3 is that the address converter 6 is omitted, and the wait control unit 37 and processed address register 34 are installed.

3 denotes a CPU, 9 denotes a DMA, 4 denotes a storage device, 7 denotes a bi-directional address bus for transferring address data among the CPU 3, the storage device 4 and the DMA 9, 8 denotes a bi-directional data bus for transferring data among the CPU 3, the storage device 4 and the DMA 9, 10 denotes a MAC comprising a data buffer for controlling connection with a network, 11 denotes a PHY which is a physical interface with a network, 12 denotes a data bus for transferring data from the DMA 9 to the data bus 8, 13 denotes a data bus for transferring data from the data bus 8 to the DMA 9, 14 denotes an address bus for transferring address data from the DMA 9 to the address bus 7, 15 denotes an address bus for transferring address data from the address bus 7 to the DMA 9, 16 denotes a received data transfer request signal which is output from the CPU 3 to the DMA 9 for instructing the transfer of data received by the MAC 10 via the PHY 11 to the storage device 4, 17 denotes a transmission data transfer request signal which is output from the CPU 3 to the DMA 9 for instructing the transfer of data of the storage device 4 to the MAC 10, 18 denotes a data bus for transferring data from the data bus 8 to the CPU 3, and 19 denotes a data bus for transferring data from the CPU 3 to the data bus 8.

215 denotes an address bus for transferring address data from the CPU 3 to the address bus 7, 22 denotes a read request signal which the CPU 3 outputs to the storage device 4 for instructing the storage device 4 to read data, 23 denotes a write request signal which the CPU 3 outputs to the storage device 4 for instructing the storage device 4 to write data, 24 denotes a write request signal which the DMA 9 outputs to the storage device 4 for instructing the storage device 4 to write data, 25 denotes a read request signal which the DMA 9 outputs to the storage device 4 for instructing the storage device 4 to read data, 26 denotes a data bus for transferring data from the data bus 8 to the storage device 4, 27 denotes a data bus for transferring data from the storage device 4 to the data bus 8, 28 denotes an address bus for transferring address data from the address bus 7 to the storage device 4, 29 denotes an address bus for transferring address data from the DMA 9 to the MAC 10, 45 denotes a data bus for receiving data for the MAC 10 to transfer the received data received from the network to the DMA 9, 31 denotes a data bus for transmission for the DMA 9 to transfer the transmission data to be transmitted to the network to the MAC 10, 32 denotes a read request signal which the DMA 9 outputs to the MAC 10 for reading the received data from the data buffer of the MAC 10, and 33 denotes a write request signal which the DMA 9 outputs to the MAC 10 for storing the transmission data to the data buffer of the MAC 10.

The processed address register 34 stores the final address of the storage area in the storage device 4, where data for which packet processing has completed is stored. 35 denotes a processed address update instruction which the CPU 3 outputs to the processed address register 34. The wait control unit 37 outputs the wait instruction 41 to the DMA 9 based on the transfer destination address data 38 when data is transferred from the DMA 9 to the storage device 4, and on the processed address data 39 stored in the processed address register 34. The operation of the wait control unit 37 will be described later.

The data bus 12 and the data bus 13, the address bus 14 and the address bus 15, the data bus 18 and the data bus 19, the data bus 26 and the data bus 27, and the data bus for receiving 45 and the data bus for transmission 31 may be constructed by a bi-directional bus respectively.

In this configuration, the data received by the PHY 11 is temporarily stored in the data buffer of the MAC 10. To transfer the received data temporarily stored in the data buffer to the storage device 4, the CPU 3 outputs the received data transfer request signal 16 and the first address data to be the data transfer destination in the storage device 4 to the DMA 9. At this time, the address data that the CPU 3 outputs is input to the DMA 9 via the address bus 215, address bus 7 and address bus 15. When the received data transfer request signal 16 and the address data are input, the DMA 9 starts transferring the received data, which is temporarily stored in the data buffer of the MAC 10, to the storage area of the storage device 4 indicated by the address data which was input from the data buffer of the MAC 10. At this time, the DMA 9 infinitely loops the transfer destination address in the storage device 4 within a predetermined area.

Now the function to infinitely loop the transfer destination address within a predetermined area by the DMA 9 will be described with reference to the drawings.

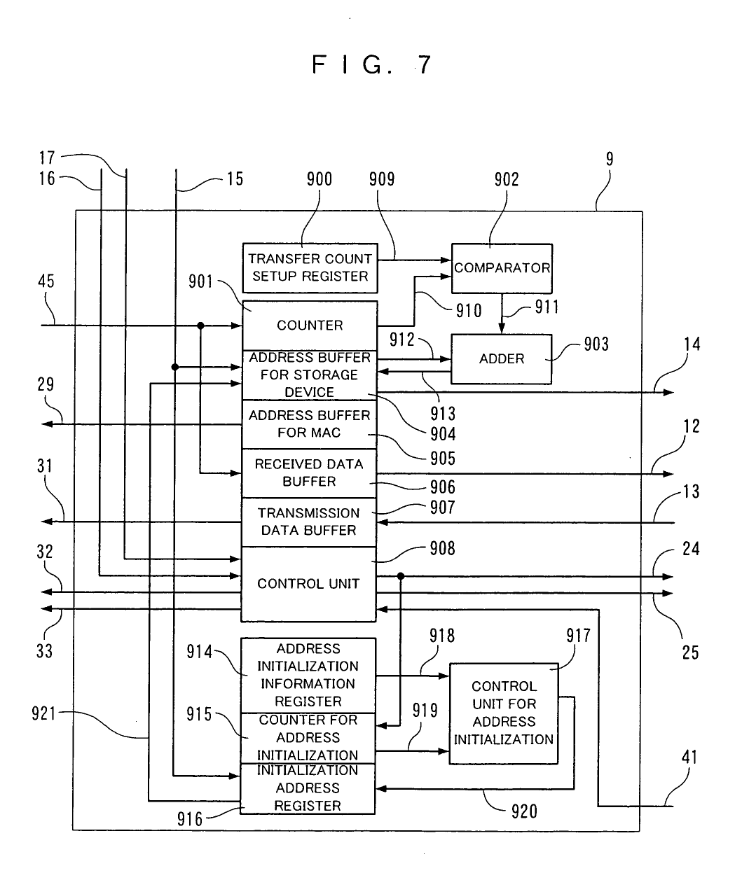

FIG. 7 is a block diagram depicting the configuration of the DMA 9. Here 900 denotes a transfer count setup register, 901 denotes a counter for counting the transfer count of the data which is input from the data bus for receiving 45, 902 denotes a comparator for comparing the value of the transfer count setup register 900 and the value of the counter 901, 903 denotes an adder for adding the address data according to the comparison result of the comparator 902, 904 denotes an address buffer for the storage device for storing address data to specify the address in the storage device 4 in FIG. 6, 905 denotes an address buffer for MAC for storing address data for specifying the address in the data buffer of the MAC 10 in FIG. 6, 906 denotes a received data buffer for storing the data which is input from the data bus for receiving 45, 907 denotes a transmission data buffer for storing the data which is input from the data bus 13, and 908 denotes a control unit. 909 denotes a transfer count information, 910 denotes a count value of the counter 901, 911 denotes a comparison result which is output from the comparator 902 to the adder 903 and the control unit 908, 912 denotes an address data which is input from the address buffer for the storage device 904 to the adder 903, 913 denotes an address data which is output from the adder 903 to the address buffer for storage device 904, 914 denotes an address initialization information register, 915 denotes a counter for address initialization for counting data transfer count from the DMA 9 to the storage device 4, 916 denotes an initialization address register, 917 denotes a control unit for address initialization for controlling address initialization, 918 denotes address initialization information, and 919 denotes a count value of the counter for address initialization 915. 920 denotes a transfer instruction which the control unit for address initialization 917 outputs to the initialization address register 916 for transferring address data stored in the initialization address register 916 to the address buffer for storage device 904. 921 denotes an initialization address data which is output from the initialization address register 916 to the address buffer for storage device 904.

The transfer count setup register 900 stores the transfer count information to indicate the number of addresses for which data is transferred from the DMA 9 to the storage device 4 continuously.

When the received data transfer request signal 16 and address data are input from the CPU 3 to the DMA 9, the received data transfer request signal 16 is input to the control unit 908, and the address data is stored in the address buffer for storage device 904 via the address bus 15. When the received data transfer request signal 16 is input to the control unit 908, the control unit 908 outputs the read request signal 32 to the MAC 10, and outputs the address data to be the read destination of the data buffer of the MAC 10 to the address bus 29. The address data which is output to the address bus 29 is the address data stored in the address buffer for the MAC 905, and the address data stored in the address buffer for MAC 905 is sequentially updated by the control unit 908. By the read request signal 32 and the address data of the address bus 29, the received data stored in the data buffer of the MAC 10 is transferred to the DMA 9 via the data bus for receiving 45, and is stored in the received data buffer 906. At this time, the control unit 908 continuously outputs the read request signal 32 to the MAC 10, and continuously outputs the address data stored in the address buffer for MAC 905 to the address bus 29, so that data can be continuously transferred from the data buffer of the MAC 10 to the DMA 9.

The counter 901 counts the transfer count of the data which is input from the data bus for receiving 45. The count value 910 of the counter 901 is input to the comparator 902. The comparator 902 compares the transfer count information 909 which is input from the transfer count setup register 900 and the count value 910 which is input from the counter 901, and outputs the comparison result 911 to the adder 903 and the control unit 908. If the comparison result 911 which was input indicates that the count value 910 is the same or less than the transfer count information 909, the adder 903 increments the address data 912 which was read from the address buffer for storage device 904, and stores this in the address buffer for storage device 904 as the address data 913. If the comparison result 911 which was input indicates that the count value 910 is the same or less than the transfer count information 909, the control unit 908 continues the data transfer control, and if the comparison result 911 which was input indicates that the count value 910 is greater than the transfer count information 909, the control unit 908 ends the data transfer control. When the address buffer for storage device 904 becomes full, the control unit 908 outputs the address data stored in the address buffer for storage device 904 to the address bus 14, and sequentially outputs the data stored in the data buffer for receiving 906 to the data bus 12, and outputs the write request signal 204 to the storage device 4 and the counter for address initialization 915. The address data which is output to the address bus 14 is input to the storage device 4 via the address bus 7 and address bus 28, and the data which is output to the data bus 12 is input to the storage device 4 via the data bus 8 and data bus 26.

In this case, the data transfer from the DMA 9 to the storage device 4 is started when the address buffer for storage device 904 becomes full, but data transfer from the DMA 9 to the storage device 400 may be sequentially executed each time one address data is stored in the address buffer for storage device 904.

Now the function to infinitely loop the transfer destination address within a predetermined area when the DMA 9 transfers the data to the storage device 4 will be described.

The address initialization information register 914 stores address initialization information in advance, which indicates how many times, that is how many address data is transferred from the DMA 9 to the storage device 4 to initialize the transfer destination address.

The address data, which is input from the CPU 3 to the DMA 9, is also stored in the initialization address register 916 via the address bus 15. The write request signal 24, to be output for transferring data from the DMA 9 to the storage device 4, is also input to the counter for address initialization 915. The counter for address initialization 915 counts the input count of the write request signal 24, that is the data transfer count from the DMA 9 to the storage device 4. The control unit for address initialization 917 sequentially reads the address initialization information 918 and the count value 919 from the address initialization information register 914 and counter for address initialization 915, compares the values. The control unit for address initialization 917 outputs the transfer instruction 920 to the initialization address register 916 and transfer the initialization address data 921 to the address buffer for storage device 904 if the count value 919 is the same or more than the address initialization information 918. As a result, the initial address data is stored in the address buffer for storage device 904, and a function to infinitely loop the transfer destination address within a predetermined area when the DMA 9 transfers data to the storage device 4 is implemented.

The function to infinitely loop the transfer destination address within a predetermined area when the DMA 9 transfers data to the storage device 4 was described above, and now a function to prevent an overwrite of the data on a packet processing uncompleted area in the storage device 4 at the infinite loop of an address will be described including the operation of the wait control unit 37.

In the processed address register 34 in FIG. 6, the address data on the final address of the area, for which packet processing by the CPU 3 has completed, is stored, and this address data is sequentially updated by the processed address update instruction 35 to be output by the CPU 3. In the wait control unit 37, the transfer destination address data 38 for transferring data from the DMA 9 to the storage device 4 is input from the address bus 7.

The wait control unit 37 reads the processed address data 39 from the processed address register 34, calculates the difference of addresses between the processed address data 39 and the transfer destination address data 38, and outputs the wait instruction 41 to the DMA 9 if the calculated address difference value is a predetermined value or less.

In the DMA 9 shown in FIG. 7, the wait control instruction 41, which is output from the wait control unit 37, is input to the control unit 908, and when the wait instruction 41 is received, the control unit 908 immediately allows the data transfer processing by the DMA 9 to temporarily wait. The period of temporarily waiting may be a predetermined time which is set in advance, or a period during which the wait instruction 41 is being input. By this, an overwrite of the data to the packet processing uncompleted area in the storage device 4 can be prevented.

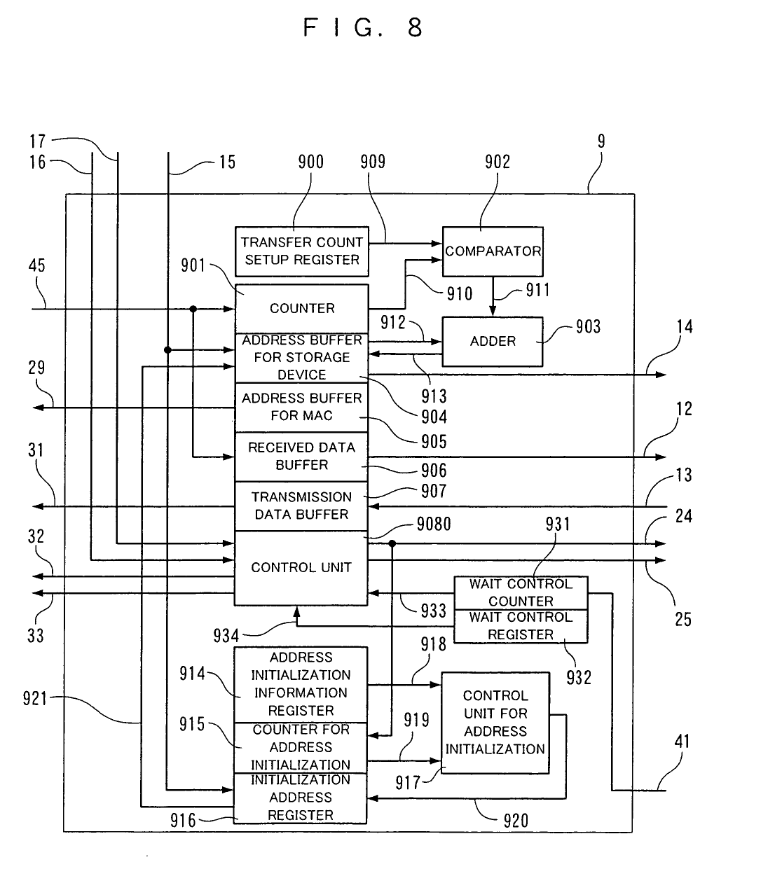

The DMA 9 may have the configuration shown in FIG. 8.

In FIG. 8, 931 denotes a wait control counter for counting the input count of the wait instruction 41 which is input from the wait control unit 37 to the DMA 9, 932 denotes a wait control register, 9080 denotes a control unit, 933 denotes a count value of the wait control counter 931, and 934 denotes a wait control information which is stored in the wait control register 932 in advance. The wait control information 934 indicates the input count of the wait instruction 41 to the DMA 9, at which the data transfer processing by the DMA 9 temporarily waits. The control unit 9080 has an advanced function of the control unit 908 in FIG. 7, so that the data transfer processing by the DMA 9 can temporarily wait. Other functions are the same as the control unit 908.

When the wait instruction 41 is input to the DMA 9 shown in FIG. 8, the input count of the wait instruction 41 is counted by the wait control counter 931, and the counting result is output to the control unit 9080 as the count value 933. The control unit 9080 reads the wait control information 934 from the wait control register 932, compares the count value 933 and the wait control information 934, and allows the data transfer processing by the DMA 9 to temporarily wait if the count value 933 is equal to or more than the wait control information 934. The temporary wait period may be a predetermined time which is set in advance, or may be a period during which the wait instruction 41 is being input. By this, an overwrite of the data to the packet processing uncompleted area in the storage device 4 can be prevented.

### Fourth Embodiment

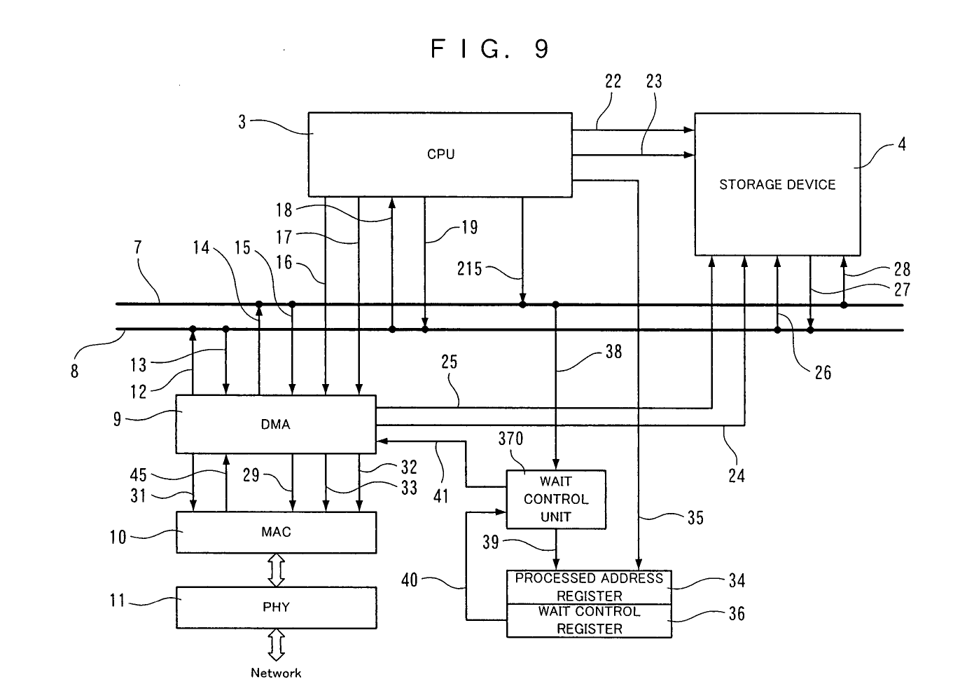

FIG. 9 is a block diagram depicting the configuration of the fourth embodiment of the packet processing device of the present invention.

Here 36 denotes a wait control register, 40 denotes an address difference information stored in the wait control register 36, and 370 denotes a wait control unit. The wait control unit 370 outputs the wait instruction 41 to the DMA 9 based on the transfer destination address data 38 for transferring data from the DMA 9 to the storage device 4, the processed address data 39 stored in the processed address register 34, and the address difference information 40 stored in the wait control register 36.

The difference between the fourth embodiment of the packet processing device of the present invention and the third embodiment shown in FIG. 6 is that the configuration of the wait control unit 37 is changed. The composing elements other than the wait control unit 370, wait control register 36 and address difference information 40 are the same as those in FIG. 6. The DMA 9 in FIG. 9 may have either the configuration of FIG. 7 or of FIG. 8.

The wait control register 36 in FIG. 9 stores, in advance, the address difference information for indicating, as a timing to instruct the DMA 9 to wait, to what extent the address interval should be narrowed between the final address of the area for which the packet processing by the CPU 3 has completed in the storage device 4 and the transfer destination address at which the DMA 9 transfers data to the storage device 4.

The wait control unit 370 reads the processed address data 39 and the address difference information 40 from the processed address register 34 and the wait control register 36, and calculates the address difference between the processed address data 39 and the transfer destination address data 38. Then the calculated address difference value and the address difference information 40 are compared, and if the calculated address difference value is the same as or less than the address difference information 40, the wait control unit 370 outputs the wait instruction 41 to the DMA 9.

When the wait instruction 41 is input from the wait control unit 370, the DMA 9 allows the data transfer processing to wait for a predetermined time. By this, an overwrite of the data to the packet processing uncompleted area in the storage device 4 can be prevented.

### Fifth Embodiment

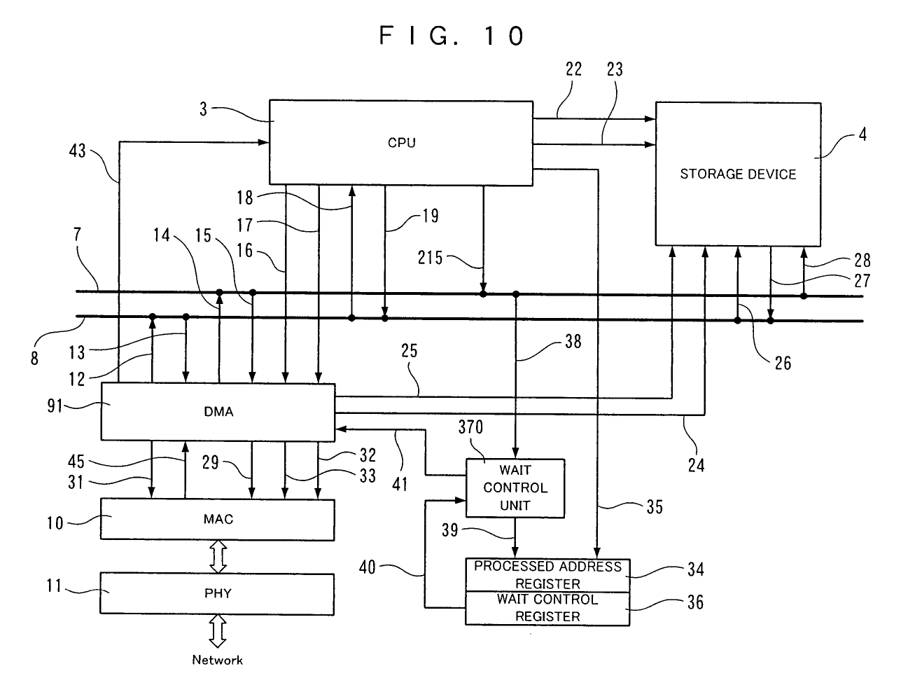

FIG. 10 is a block diagram depicting the configuration of the fifth embodiment of the packet processing device of the present invention.

Here 3 denotes a CPU, 91 is a DMA and 43 denotes an interrupt request signal which the DMA 91 outputs to the CPU 3.

The difference between the fifth embodiment of the packet processing device of the present invention and the packet processing device of the fourth embodiment in FIG. 9 is that the functions of the CPU 3 and the DMA 91 are changed. The CPU 3 has a function to receive the interrupt request signal 43 from the DMA 91, and the DMA 91 controls the interrupt to the CPU 3. Other composing elements are the same as those in FIG. 9.

Now the DMA 91 will be described with reference to the drawings.

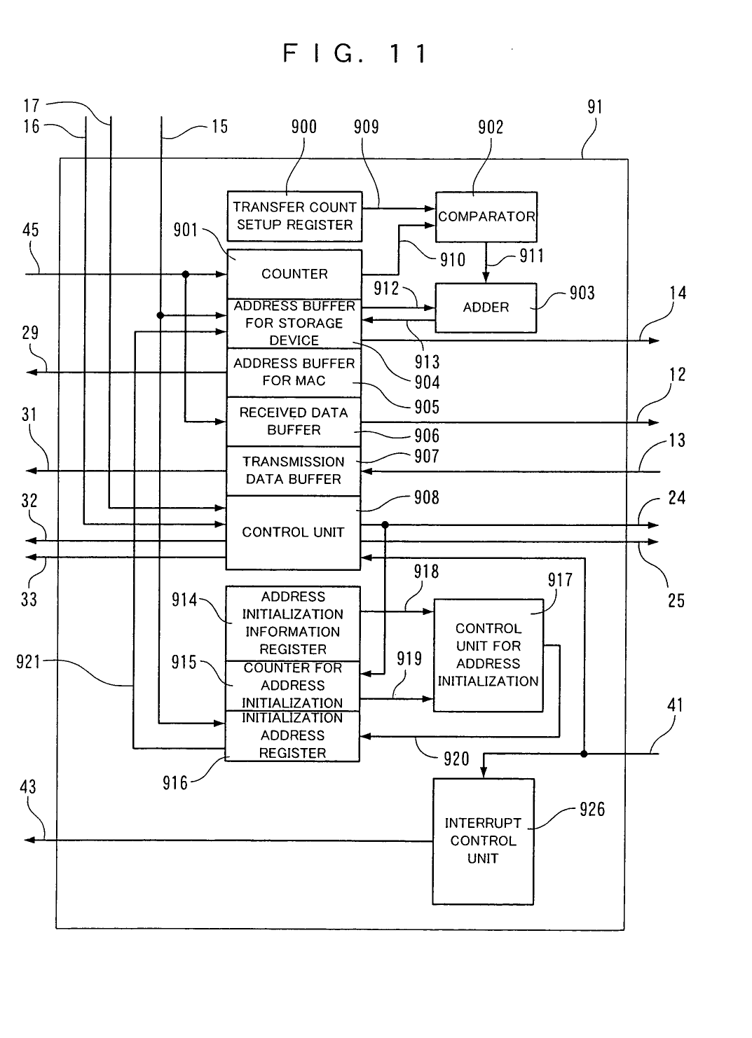

FIG. 11 is a block diagram depicting the configuration of the DMA 91 shown in FIG. 10. Here 926 denotes an interrupt control unit.

When the wait instruction 41 is input from the wait control unit 370 to the DMA 91 in FIG. 10, this wait instruction 41 is input to the control unit 908 and the interrupt control unit 926 of the DMA 91.

When the wait instruction 41 is received, the control unit 908 immediately allows the data transfer processing by the DMA 91 to wait for a predetermined time. On the other hand, when the wait instruction 41 is received, the interrupt control unit 926 immediately outputs the interrupt request signal 43, of which the priority level is always constant, to the CPU 3. By this, when the wait instruction 41 is issued to the DMA 91, not only data transfer from the DMA 91 to the storage device 4 temporarily waits, but the priority of the packet processing for tasks other than the packet processing by the CPU 3 is increased. As a result, a drop in throughput can be prevented.

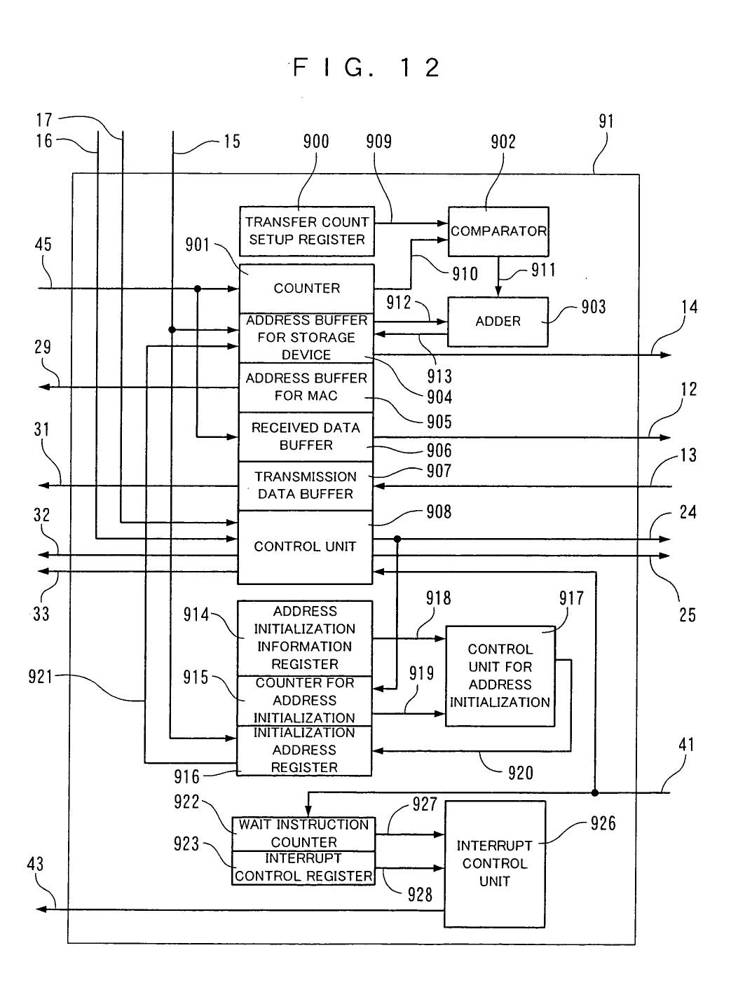

The DMA 91 may have the configuration shown in FIG. 12.

In FIG. 12, 926 denotes an interrupt control unit. 922 denotes a wait instruction counter for counting the input count of the wait instruction 41 which is input from the wait control unit 370 to the DMA 91 in FIG. 10. 923 denotes an interrupt control register, 927 denotes a count value of the wait instruction counter 922, and 928 denotes an interrupt control information.

In the interrupt control register 923, interrupt control information, to indicate the count of the input of the wait instruction 41 at which the interrupt request is issued to the CPU 3, is stored in advance.

In FIG. 12, when the wait instruction 41 is input from the wait control unit 370 to the DMA 91 in FIG. 10, the wait instruction 41 is input to the control unit 908 and the wait instruction counter 922. When the wait instruction 41 is received, the control unit 908 immediately allows the data transfer processing by the DMA 91 to wait for a predetermined time. On the other hand, the wait instruction counter 922 counts the input count of the wait instruction 41, and outputs the count value 927 to the interrupt control unit 926. The interrupt control unit 926 reads the interrupt control information 928 from the interrupt control register 923, and compares the count value 927 and the interrupt control information 928. If the count value 927 is the same or more than the interrupt control information 928 as a result of the comparison, the interrupt request signal 43, of which the priority level is always constant, is output to the CPU 3. By this, the priority of the packet processing for tasks other than the packet processing by the CPU 3 is improved, and it becomes possible not only to prevent a drop in throughput, but to make a more flexibly interrupt request to the CPU 3 according to the degree of frequency of the wait instruction 41 issued to the DMA 91.

### Sixth Embodiment

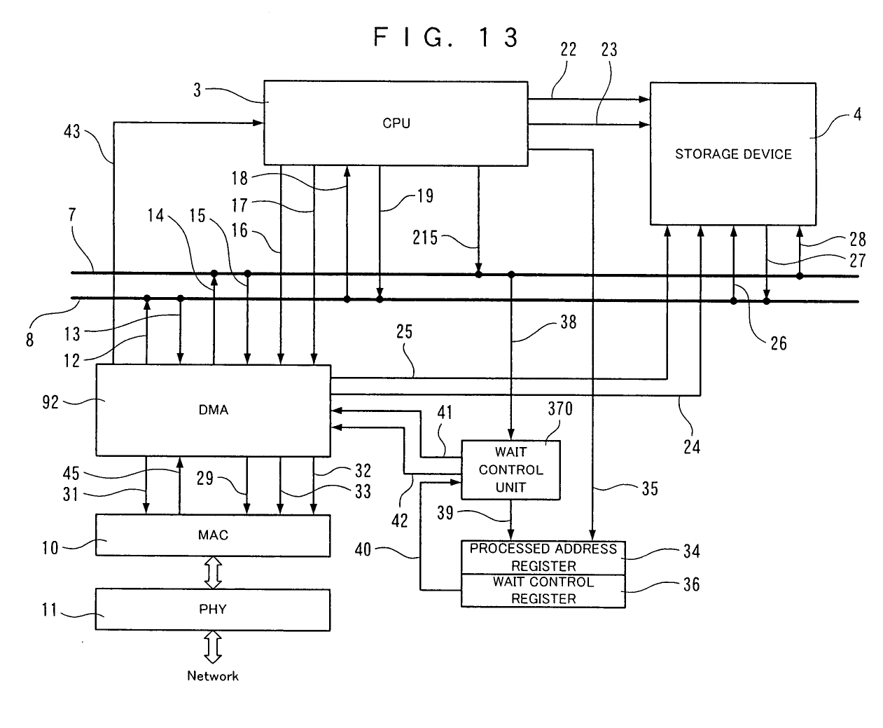

FIG. 13 is a block diagram depicting the configuration of the sixth embodiment of the present invention.

Here 370 denotes a wait control unit, 92 denotes a DMA, 42 denotes an address difference information which is output from the wait control unit 370 to the DMA 92.

The difference between the packet processing device of the sixth embodiment and the packet processing device of the fifth embodiment in FIG. 10 is that the functions of the wait control unit 370 and the DMA 92 are changed, in which the wait control unit 370 has a function to output the address difference information 42 to the DMA 92, and the DMA 92 has a function to arbitrarily change the priority level according to the address difference information 42 in the interrupt control to the CPU 3. Other functions are the same as those in FIG. 10.

The wait control unit 370 in FIG. 13 reads the processed address data 39 and the address difference information 40 from the processed address register 34 and the wait control register 36, and calculates the address difference between the processed address data 39 and the transfer destination address data 38. Then the calculated address difference value and the address difference information 40 are compared, and if the calculated address difference value is the same as or less than the address difference information 40, the wait control unit 370 outputs the wait instruction 41 to the DMA 92. At this time, the wait control unit 370 outputs the calculated address difference value to the DMA 92 as the address difference information 42.

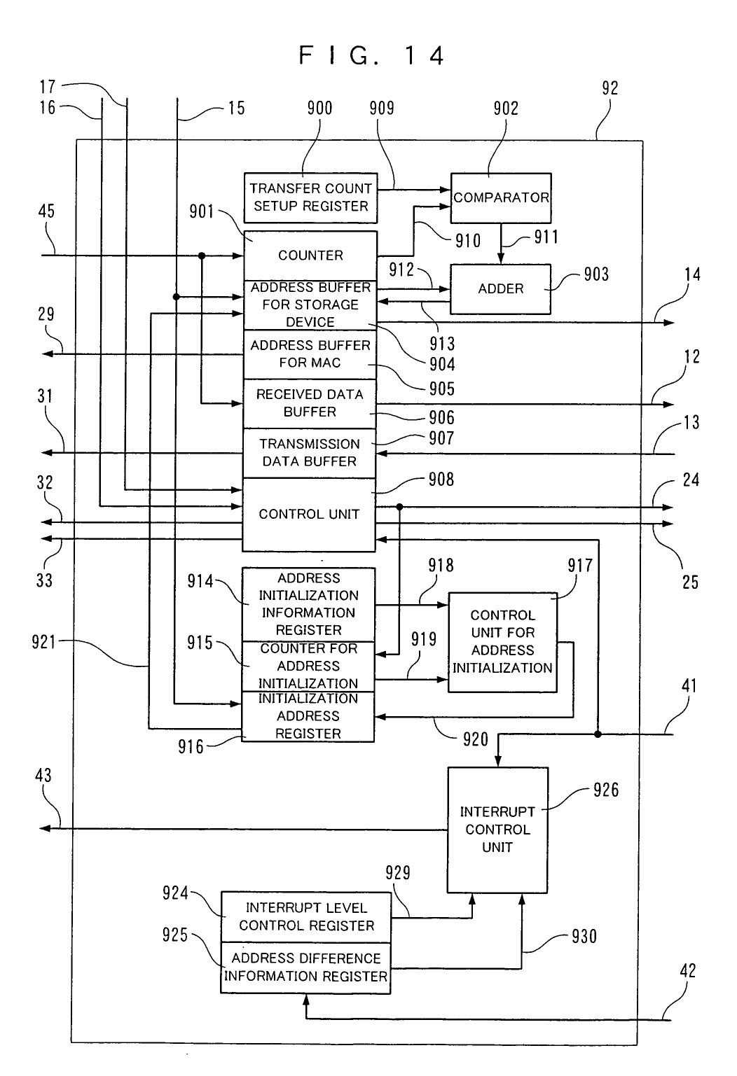

FIG. 14 is a block diagram depicting the configuration of the DMA 92 shown in FIG. 13. Here 926 denotes an interrupt control unit, 924 denotes an interrupt level control register, 925 denotes an address difference information register, 929 is an interrupt level control information and 930 denotes address difference information.

In the interrupt level control register 924, the interrupt level control information, for setting the priority level of the interrupt according to the address difference information 930, is stored in advance. This interrupt level control information is information to correspond the priority level of the interrupt to the address difference information, such as the priority level of the interrupt is “1” if the address difference information is “A”, the priority level of the interrupt is “2” if the address difference information is “B”, and the priority level of the interrupt is “3” if the address difference information is “C”.

In the DMA 92 in FIG. 14, the wait instruction 41, which is input from the wait control unit 370 in FIG. 13, is input not only to the control unit 908 but also to the interrupt control unit 926. The address difference information 42, which is input from the wait control unit 370, is stored in the address difference information register 925. When the wait instruction 41 is received, the interrupt control unit 926 reads the interrupt level control information 929 and the address difference information 930 from the interrupt control register 924 and the address difference information register 925. Then the interrupt control unit 926 detects the interrupt level which corresponds to the address difference information 930 which is read, with reference to the interrupt level control information 929, and outputs the interrupt request signal having the priority level according to the detection result to the CPU 3 as the interrupt request signal 43. By this, if a wait instruction 41 to the DMA 92 is generated, an interrupt request having the priority level according to the address difference can be issued to the CPU 3, and the priority of the packet processing for tasks other than the packet processing by the CPU 3 can be flexibly improved, such as an interrupt request signal with a higher priority level is output as the address difference becomes smaller.

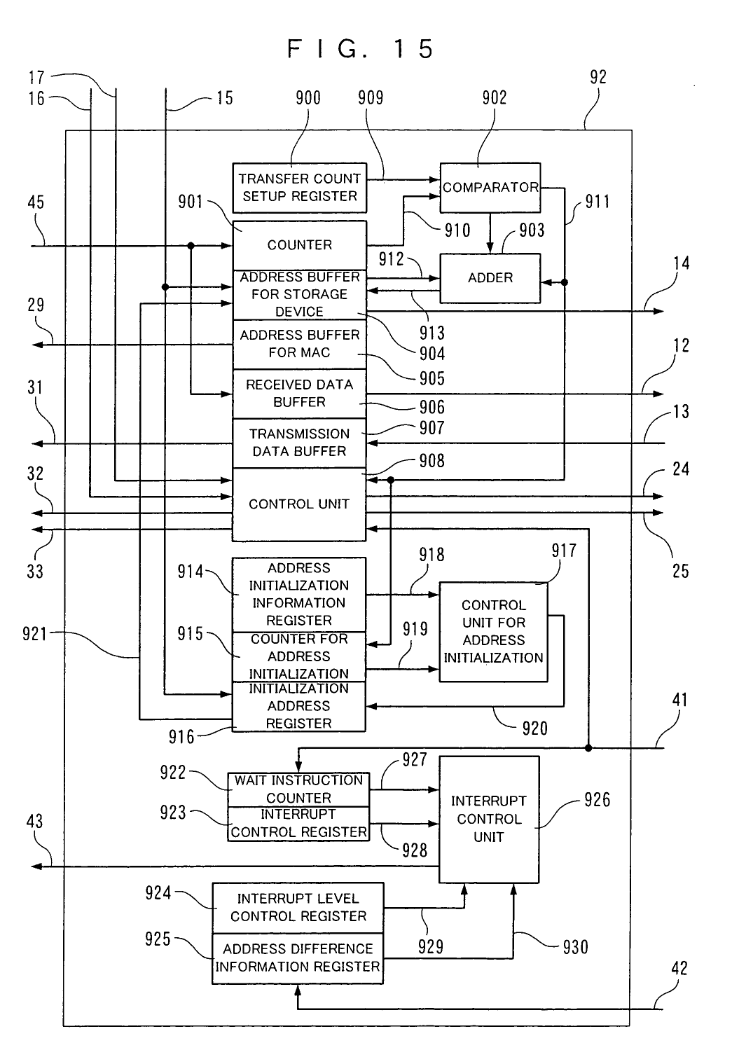

The DMA 92 may have the configuration shown in FIG. 15. In FIG. 15, the wait instruction 41, which is output from the wait control unit 370 in FIG. 13, is input to the wait instruction counter 922, and the address difference information 42, which is output from the wait control unit 370, is stored in the address difference information register 925. The wait instruction counter 922 counts the input count of the wait instruction 41, and outputs the count value 927 to the interrupt control unit 926. The interrupt control unit 926 reads the interrupt control information 928 from the interrupt control register 923, and compares the count value 927 and the interrupt control information 928. If the count value 927 is the same as or more than the interrupt control information 928 as a result of comparison, this means that it is necessary to increase the priority of the packet processing for tasks other than the packet processing by the CPU 3. If the count value 927 is the same as or more than the interrupt control information 928, the interrupt control unit 926 reads the interrupt level control information 929 and the address difference information 930 from the interrupt level control register 924 and the address difference information register 925. Then referring to the interrupt level control information 929, the interrupt control unit 926 detects the interrupt level corresponding to the address difference information 930 which was read, and outputs the interrupt request signal 43 having the priority level according to the detection result to the CPU 3. By this, when the wait instruction 41 to the DMA 92 is issued frequently, an interrupt request with the priority level according to the degree of frequency of the wait instruction 41 issued to the CPU 3 and the address difference at that time becomes possible, and the flexibility of the packet processing for tasks other than the packet processing by the CPU 3 can be improved, such as an interrupt request signal with a higher priority level is output as the address difference becomes smaller.

1. A packet processing method for converting data into packets conforming to a communication protocol for communicating between networks, comprising steps of:
dividing said data into a plurality of divided data with a predetermined data length;
storing said divided data;
securing a first blank area corresponding to said divided data in an area before a storage area for storing each of said divided data;
securing a second blank area corresponding to said divided data in an area after the storage area for storing each of said divided data;
storing a protocol header to be attached in said first blank area when the packet conversion processing is executed on said divided data;
storing a protocol footer to be attached in said second blank area when the packet conversion processing is executed on said divided data; and
identifying the data in the storage area including the protocol header and protocol footer attached to each divided data, as one packet.

2. A packet processing device for implementing the packet processing method according to claim 1, comprising:
a storage device for storing data;
a transfer device for dividing said data into a plurality of data with a predetermined length and arranging the divided data at intervals in said storage device while securing a first blank area for attaching a protocol header to said divided data and a second blank area for attaching a protocol footer to said divided data;
a read address control device for implementing access of the data arranged at intervals in said storage device as continuous data; and
a write address control device for storing the protocol header to be attached in said first blank area and protocol footer to be attached in said second blank area when the packet conversion processing is executed on said divided data.

3. The packet processing device according to claim 2, further comprising a register for arbitrarily setting the data length of the divided data, the size of the first blank area and the size of the second blank area respectively.

4. The packet processing device according to claim 2, wherein the transfer device comprises a function to continuously transfer data while adding an arbitrary value to a transfer destination address for each transfer count being set when the data is transferred from the transfer source to the transfer destination, and implements the arrangement of the divided data at intervals in the storage device by continuously transferring the next data with adding the sum of the address count in the first blank area and the address count in the second blank area to the transfer destination address, each time data is transferred to the storage device for the amount corresponding to the data length of the divided data.

5. The packet processing device according to claim 2, wherein the read address control device and the write address control device are updated each time the protocol header and/or protocol footer are/is attached, and the packet processing device further comprises a first register to indicate the size of the divided data storage area in the storage device at an arbitrary point of time, a second register to be updated each time a protocol header is attached and to indicate the size of the blank area for storing the protocol header in said storage device at an arbitrary point of time, and a third register to be updated each time a protocol footer is attached and to indicate the size of the blank area for storing the protocol footer in said storage device at an arbitrary point of time.

6. The packet processing device according to claim 5, wherein the read address control device comprises a function to calculate the size of the blank area between the divided data stored in the storage device from the sum of the value of the second register and the value of the third register, and wherein the read address control device can implements continuous access to said divided data arranged at intervals by adding the calculated value to the address of the access destination for each read count corresponding to the value of the first register when said divided data is accessed from outside of said storage device.

7. The packet processing device according to claim 5, wherein the write address control device further comprises a function to calculate an interval address value of the protocol header storage area corresponding to each divided data by multiplying the sum of the value of the first register, the value of the second register and the value of the third register by the count of attaching the protocol header and then adding an offset value after the size of the protocol header to be attached is subtracted from the value of the second register, and to calculate an interval address value of the protocol footer storage area corresponding to each divided data by multiplying a value after the size of the protocol footer to be attached is subtracted from the sum of the value of the first register, the value of the second register and the value of the third register by the count of attaching the protocol footer, and wherein the write address control device implements attaching of the protocol header and/or the protocol footer for each of said divided data arranged at intervals in said storage device by adding the calculated value to the address of the storage destination each time one protocol header and/or one protocol footer are/is stored in the storage device.

8. The packet processing device according to claim 7, further comprising device for previously setting the size of the protocol header and/or the protocol footer to be attached for each protocol.

9. The packet processing device according to claim 7, wherein the size of the protocol header and/or the protocol footer to be attached are/is calculated every time it is/they are attached, by a counter for counting the respective data length.

10. A packet processing device, comprising a storage device for storing data, a CPU for executing packet processing on the data stored in said storage device, and a transfer device for transferring data between said storage device and said CPU, wherein said transfer device infinitely loops the transfer destination address in said storage device within a predetermined area by initializing the transfer destination address of the data for each transfer count that is arbitrarily settable.

11. The packet processing device according to claim 10, further comprising a wait instruction control device for calculating the difference between the final address of the storage area storing data for which packet processing is completed in the storage device and a transmission destination address when data is transmitted from the transfer device to said storage device, and outputting a wait control signal to said transfer device when the calculated address difference value is smaller than an address difference value that was preset.

12. The packet processing device according to claim 11, wherein the wait instruction control device further comprises a register for setting the address difference value.

13. The packet processing device according to claim 11, wherein the transfer device temporarily stops data transfer from said transfer device to the storage device when a wait control signal is input from the wait instruction control device.

14. The packet processing device according to claim 11, wherein the transfer device further comprises a counter for counting the input count of a weight control signal to be input from the wait instruction control device, and a control unit for temporarily stopping data transfer from said transfer device to the storage device when the count value of this counter reaches a preset value.

15. The packet processing device according to claim 13, wherein when a wait control signal is input from the wait instruction control device, the transfer device outputs a notification signal to the CPU so as to increase the priority of the packet processing for the other tasks by said CPU.

16. The packet processing device according to claim 14, wherein when the count value by the counter reaches a preset value, the transfer device outputs a notification signal to the CPU so as to increase the priority of the packet processing for the other tasks by said CPU.

17. The packet processing device according to claim 15, wherein the notification signal is an interrupt request signal having a priority level.

18. The packet processing device according to claim 17, wherein when an interrupt request is output to the CPU, the transfer device outputs an interrupt request with a priority level corresponding to the calculated address difference value.

19. The packet processing device according to claim 18, wherein the transfer device outputs an interrupt request with a higher priority level to increase the priority of the packet processing as the calculated address difference value becomes smaller.
